(19) United States
(12) Patent Application Publication
(10) Pub. No.: US 2020/0208023 A1
(43) Pub. Date: Jul. 2, 2020

(54) ADHESIVE COMPOSITION, ORGANIC FIBER AND TREATING METHOD THEREOF, AND METHOD OF FORMING ORGANIC FIBER/RUBBER COMPOSITE

(71) Applicant: Far Eastern New Century Corporation, Taipei (TW)

(72) Inventors: Wen-Teng CHANG, Taoyuan City (TW); Yu-Ting LEE, Taoyuan City (TW)

(21) Appl. No.: 16/703,044

(22) Filed: Dec. 4, 2019

(30) Foreign Application Priority Data
Dec. 27, 2018 (TW) 107147510

(51) Int. Cl. C09J 109/00; C09J 5/00; C08J 5/24; C08J 5/12

(52) U.S. Cl. CPC C09J 109/00; C09J 5/00; C08J 5/24; C08J 5/128; C09J 2475/00; C09J 2409/00; C08J 2321/00; C09J 2467/008; C09J 2477/008; C09J 2421/008; C08J 2367/02; C08J 2377/06; C08J 2377/10; C09J 2400/266

(57) ABSTRACT

The invention provides an adhesive composition. The adhesive composition includes a halohydrin compound, a blocked isocyanate compound and latex, in which the adhesive composition does not include resorcinol, formaldehyde and epoxy compound. The invention also provides a method for treating organic fiber. The method includes impregnating an organic fiber or a fabric with the abovementioned adhesive composition; and drying the organic fiber or the fabric.

### CROSS-REFERENCE TO RELATED APPLICATION

This application claims priority to Taiwan Application Serial Number 107147510, filed Dec. 27, 2018, which is herein incorporated by reference.

### BACKGROUND

### Field of Invention

The present disclosure relates to an adhesive composition that does not include resorcinol, formaldehyde and epoxy compound, and a method of treating the organic fiber and a method of treating the organic fiber/rubber composite.

### Description of Related Art

Polar functional groups (such as amide group, hydroxyl group, or carbonyl group) in the structure of organic fiber are incompatible with the non-polar structure of rubber. Conventional resorcinol-formaldehyde-latex adhesive composition (commonly known as RFL adhesive composition) has been widely used in organic fiber/rubber composite products (such as tires, hoses, conveyor belts or belts).

Conventional impregnated inert organic fiber cord fabric is prepared by a two-stage impregnation process, which is complicated and may increase the cost. For example, U.S. Patent Application Publication No. US2017/0167074A1 discloses a process of forming impregnated organic fiber cord fabric by using two impregnation stages. In the first impregnation stage, a composition comprising a halohydrin compound and a blocked isocyanate compound is used to activate the organic fiber, followed by drying the organic fiber to obtain an activated organic fiber. The second impregnation stage is carried out subsequently, in which the activated organic fiber is impregnated with RFL adhesive composition to form the impregnated organic fiber cord fabric.

However, the inventors of the present invention have studied and discovered that the conventional two-stage impregnation process is time-consuming and labor-intensive, and the compatibility between the activated organic fiber, which comprises a halohydrin compound and a blocked isocyanate compound, and the RFL adhesive composition is poor. Therefore, the heat resistance and fatigue resistance of the impregnated organic fiber cord fabric are insufficient.

Furthermore, formaldehyde in the RFL adhesive composition is carcinogenic and may pose a hazard to operators. Moreover, resorcinol in the RFL adhesive composition is a suspected environmental hormone, which may also pose a hazard to the environment.

In addition, the use of two impregnation stages in the preparation of impregnated organic fiber cord fabric is costly. Accordingly, there is an important topic to devise a low-cost adhesive, which poses no hazard to operators and the environment, and also shows improved heat resistance and fatigue resistance when the organic fiber cord is adhered to rubber.

### SUMMARY

The present disclosure provides an adhesive composition that can be directly used for an organic fiber that is not activated. The adhesive composition of the present disclosure requires only a single-stage impregnation process, thereby reducing the process and saving cost. In addition, since formaldehyde and resorcinol are not used and therefore the adhesive composition of the present disclosure poses no hazard to the human body and the environment.

One aspect of the present disclosure is to provide an adhesive composition for bonding an organic fiber to rubber. The adhesive composition comprises a halohydrin compound, a blocked isocyanate compound and latex, and the adhesive composition does not include resorcinol, formaldehyde, and epoxy compound.

In one embodiment of the present disclosure, the halohydrin compound is a chlorohydrin compound.

In one embodiment of the present disclosure, the halohydrin compound is halogen-substituted sorbitol, halogen-substituted glycerol, or a combination thereof.

In one embodiment of the present disclosure, the halogen-substituted sorbitol is chloro-substituted sorbitol.

In one embodiment of the present disclosure, the halogen-substituted glycerol is chloro-substituted glycerol.

In one embodiment of the present disclosure, the latex is a copolymer of Styrene, butadiene and vinyl pyridine, and is commonly known as styrene butadiene vinyl-pyridine rubber latex.

Another aspect of the present disclosure is to provide a method for treating organic fiber. The method comprises a step of impregnating the organic fiber with the adhesive composition.

In one embodiment of the present disclosure, the organic fiber is selected from the group consisting of polyester fiber, nylon fiber, aromatic polyamide fiber, or a combination thereof.

In one embodiment of the present disclosure, the polyester fiber is polyethylene terephthalate fiber.

In one embodiment of the present disclosure, the nylon fiber is nylon 66 fiber.

In one embodiment of the present disclosure, the aromatic polyamide fiber is poly(m-phenylene isophthalamide) fiber.

Yet another aspect of the present disclosure is to provide an organic fiber that is prepared by the aforementioned method.

In one embodiment of the present disclosure, the organic fiber is used in the preparation of tires, hoses, conveyor belts, or belts.

Yet another aspect of the present disclosure is to provide a method of using the adhesive composition. The adhesive composition is used for bonding an organic fiber in tires, hoses, conveyor belts or belts to rubber.

It is to be understood that both the foregoing general description and the following detailed description are by examples, and are intended to provide further explanation of the invention as claimed.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. The embodiments disclosed herein may be combined or substituted with each other in an advantageous manner, and other embodiments may be added to an embodiment without further description or description. In the following description, numerous specific details are set forth. However, embodiments of the present disclosure may be practiced without these specific details.

Since the adhesive composition of the present disclosure does not contain resorcinol and formaldehyde, and therefore the adhesive composition poses no hazard to operators and the environment, as compared with conventional RFL adhesive composition. Furthermore, the adhesive composition of the present disclosure contains a halohydrin compound and a blocked isocyanate compound, and the adhesive composition has excellent adhesion performance, in which only one single impregnation stage is needed. Compared to the conventional technique of using two impregnation stages, the adhesive composition of the present disclosure is cost-effective. Moreover, the halohydrin compound and the blocked isocyanate compound, which are used to activate the organic fiber, have excellent compatibility with latex. Accordingly, an organic fiber fabric impregnated with the adhesive composition of the present disclosure and adhered to rubber has excellent physical and mechanical properties,—heat resistance, and fatigue resistance. Therefore, the adhesive composition of the present disclosure is suitable for use in a variety of organic fiber/rubber composite products.

According to various embodiments, the adhesive composition of the present disclosure comprises a halohydrin compound, a blocked isocyanate compound, and latex.

The halohydrin compound and the blocked isocyanate compound may activate the organic fiber. In detail, the surface of the organic fiber (such as polyester fiber) lacks functional groups, and therefore the organic fiber is unable to form excellent bonding with latex. Hence, according to some embodiments of the present disclosure, the halohydrin compound and the blocked isocyanate compound in the adhesive composition can be used to activate the organic fiber. In this way, functional groups are provided on the surface of the organic fiber, and therefore the organic fiber is able to form excellent bonding with latex. It is understood that only one single impregnation stage is required when using the adhesive composition of the present disclosure. Compared with the conventional technique of using two impregnation stages (in which the organic fiber is activated in the first impregnation stage, and the activated organic fiber is then impregnated with latex in the second impregnation stage), the adhesive composition of the present disclosure is cost-effective.

It is noted that the halogen content in the halohydrin compound may affect the compatibility between the halohydrin compound and the organic fiber. In detail, the higher the halogen content in the halohydrin compound, the higher the compatibility between the halohydrin compound and the organic fiber, and the adhesion performance of the adhesive composition are thereby increased. However, it is noted that when the halogen content in the halohydrin compound is excessively high, the solubility of the halohydrin compound in the aqueous solution may decrease. Therefore, according to some embodiments of the present disclosure, the halogen content in the halohydrin compound is in an appropriate range. Specifically, the halogen content in the halohydrin compound may range from 5.0 wt % to 15.0 wt %, such as 7.0 wt %, 9.0 wt %, 10.0 wt %, 12.0 wt %, or 13.0 wt %.

The halohydrin compound in the present disclosure may be a reaction product (such as halohydrin ether) of the reaction of a polyol compound and an epihalohydrin compound. Specifically, the polyol compound refers to a compound having two or more hydroxyl groups, including diol such as ethylene glycol, propanediol, polyethylene glycol, polypropylene glycol, etc., hydroxy acids such as erythritol, xylitol, sorbitol, tartaric acid, glyceric acid, etc., glycerol, diglycerol, polyglycerol, trimethylolpropane, trimethylolethane, pentaerythritol, etc. Furthermore, epihalohydrin compound may be such as epichlorohydrin or epibromohydrin, or the like, but is not limited thereto. It is noted that the adhesive composition of the present disclosure may comprise a halohydrin compound or two or more halohydrin compounds.

In some embodiments, the halohydrin compound may be such as a fluorohydrin compound, a chlorohydrin compound, a bromohydrin compound, or an iodohydrin compound. More preferably, in one embodiment, the halohydrin compound is halogen-substituted sorbitol, halogen-substituted glycerol, or a combination thereof. The halogen-substituted sorbitol may be chloro-substituted sorbitol represented by the following structural formula:

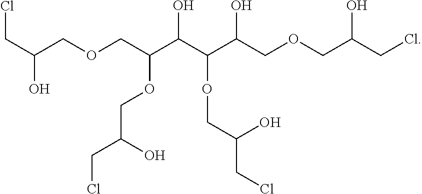 [SMILES: OC(CCl)COCC(O)C(OCC(O)CCl)C(O)C(COCC(O)CCl)OCC(O)CCl]

The halogen-substituted glycerol may be chloro-substituted glycerol represented by the following structural formula:

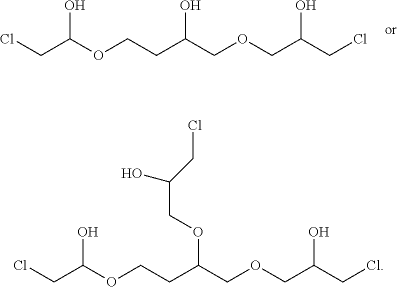 [SMILES: OC(CCl)COCC(O)CCOC(O)CCl ; OC(CCl)COCC(CCOC(O)CCl)OCC(O)CCl]

In the present disclosure, “blocked isocyanate compound” is a compound resulted from the reaction of a blocking agent and an isocyanate compound, in which the reaction is for protecting the isocyanate group (—NCO) of the isocyanate compound. For example, by elevating temperature (such as 90° C. to 250° C.), groups derived from the blocking agent may be dissociated to form isocyanate groups. In some embodiments, the isocyanate compound in the present disclosure may be a compound having two or more isocyanate groups. Specifically, the isocyanate compound include a diisocyanate compound having two isocyanate groups, such as hexamethylene diisocyanate, diphenyl methane diisocyanate, phenyl dimethylidene diisocyanate, phenylene diisocyanate, toluene diisocyanate, trimethyl hexamethylidene diisocyanate, m-phenylene diisocyanate, naphthalene diisocyanate, diphenyl ether diisocyanate, diphenylpropane diisocyanate, biphenyl diisocyanate, and the like, but is not limited thereto. Moreover, the isocyanate compound may include a tri-isocyanate compound having three isocyanate groups, a tetra-isocyanate compound having four isocyanate groups, and the like. It is noted that the adhesive composition of the present disclosure may comprise a blocked isocyanate compound or two or more blocked isocyanate compounds.

In some embodiments, the latex in the present disclosure includes butadiene-type copolymer latex, butadiene/styrene-type copolymer latex, butadiene/acrylonitrile-type copolymer latex, butadiene/vinyl pyridine copolymer, butadiene/vinyl pyridine/styrene-type copolymer latex, etc., but is not limited thereto. More preferably, in one embodiment, the latex in the present disclosure is butadiene/vinyl pyridine/styrene-type copolymer latex. For example, the latex in the present disclosure may be such as butadiene/vinyl pyridine copolymer.

According to various embodiments, the adhesive composition comprises 10.0 to 30.0 parts of weight of halohydrin compound, 10.0 to 30.0 parts of weight of blocked isocyanate compound, and 80.0 to 240.0 parts of weight of latex. More preferably, in one embodiment, the adhesive composition comprises 20.0 parts of weight of halohydrin compound, 20.0 parts of weight of blocked isocyanate compound, and 160.0 parts of weight of latex. However, it is noted that the adhesive composition of the present disclosure does not contain resorcinol and formaldehyde. Therefore, compared with the conventional RFL adhesive composition, the adhesive composition of the present disclosure poses no harm to operators and the environment.

As mentioned above, the adhesive composition of the present disclosure is suitable for use in a variety of organic fiber/rubber composite. For example, the organic fiber/rubber composite may be suitable for use in industrial products such as tires, hoses, conveyor belts, belts, or the like. In some embodiments, the organic fiber/rubber composite is formed by hot-pressing rubber to an organic fiber fabric. Specifically, organic fibers are woven into a cord or canvas, followed by adhesive impregnation treatment to form the organic fiber fabric. In detail, the adhesive composition is used to form an adhesive layer on the surface of the organic fiber cord or the organic fiber canvas to form an organic fiber fabric, and the organic fiber fabric is adhered to rubber by a hot-pressing process to form an organic fiber/rubber composite. In some embodiments, the adhesive layer may be formed by impregnation, brushing, casting, spraying, roll coating, blade coating, etc., but is not limited thereto. Accordingly, the use of the adhesive composition of the present disclosure and the organic fiber fabric in the formation of the organic fiber/rubber composite may enhance the adhesion of the organic fiber/rubber composite, and the organic fiber/rubber composite may have excellent heat resistance and fatigue resistance.

According to various embodiments, the organic fiber may be selected from polyester fiber, nylon fiber, aromatic polyamide fiber, or a combination thereof. In one embodiment, the polyester fiber may be such as polyethylene terephthalate fiber. In one embodiment, the nylon fiber may be such as nylon 66 fiber. In one embodiment, the aromatic polyamide fiber may be such as poly(m-phenylene isophthalamide) fiber.

It is noted that the adhesive composition of the present disclosure is applicable to the existing rubber, and therefore it is not necessary to change the rubber formulation for adhesion enhancement. Therefore, the rubber material is not particularly limited, besides of natural rubber, synthetic rubber such as isoprene rubber (IR), polybutadiene rubber (BR), styrene butadiene rubber (SBR), nitrile butadiene rubber (NBR), chloroprene rubber (CR), isobutylene isoprene rubber (IIR), and the like are also contemplated, but is not limited thereto.

The following examples are provided to illustrate the preparation method and technical effect of the adhesive composition of the present disclosure. However, the following examples are not intended to limit the present disclosure.

### Preparation of Halohydrin Compound

### EXAMPLE 1-1

91.0 g (0.5 mol) of sorbitol (available from Alfa-Aesar Co.) was dispersed in 100 g of toluene (available from Sigma-Aldrich Co.) with the addition of 1.42 g (0.01 mol) of boron trifluoride diethyl etherate (available from Sigma-Aldrich Co.). Next, 109.20 g (1.18 mol) of epichlorohydrin (available from Alfa-Aesar Co.) was slowly added and reacted at a constant temperature of 60° C. After the complete reaction of epichlorohydrin, which was tracked by JIS method K7236, toluene was removed by concentration under reduced pressure to obtain chloro-substituted sorbitol.

### EXAMPLE 1-2

46.05 g (0.5 mol) of glycerol (available from Alfa-Aesar Co.) was added to 1.42g (0.01 mol) of boron trifluoride diethyl etherate (available from Sigma-Aldrich Co.). Next, 109.20 g (1.18 mol) of epichlorohydrin (available from Alfa-Aesar Co.) was slowly added and reacted at a constant temperature of 60° C. After the complete reaction of epichlorohydrin, which was tracked by JIS method K7236, chloro-substituted glycerol was obtained.

Preparation of adhesive compositions

### EXAMPLE 2-1

20.0 g of chloro-substituted sorbitol, 33.0 g of isocyanate compound IL-6 (available from EMS-GRIVORY Co.; solid content=60%), 390.0 g of copolymer of butadiene and vinyl pyridine VPL0653 (available from Croslene Chemical Industries. Ltd., solid content=41%), and 557.0 g of deionized water were mixed to form an adhesive composition T1.

### EXAMPLE 2-2

20.0 g of chloro-substituted glycerol, 33.0 g of isocyanate compound IL-6, 390.0 g of copolymer of butadiene and vinyl pyridine VPL0653, and 557.0 g of deionized water were mixed to form an adhesive composition T2.

### Preparation of Conventional Pre-Impregnation Liquid

### COMPARATIVE EXAMPLE 1-1

9.0 g of sorbitol-type epoxy resin EX-614B (available from Nagase ChemteX Co.), 31.0 g of isocyanate compound IL-6, 0.4 g of surfactant OT-75 (available from Cytec Solvay Co.; concentration=75%), and 959.6 g of deionized water were mixed to form a conventional pre-impregnation liquid pre-impregnation liquid P1.

### COMPARATIVE EXAMPLE 1-2

9.0 g of glycerin-type epoxy resin EX-313 (available from Nagase ChemteX Co.), 31.0 g of isocyanate compound IL-6, 0.4 g of surfactant OT-75, and 959.6 g of deionized water were mixed to form a conventional pre-impregnation liquid pre-impregnation liquid P2.

### Preparation of an Impregnated Organic Fiber Cord Fabric

### EXAMPLE 3-1

Polyester yarn (available from Oriental Industries (Suzhou) Ltd.; content: polyethylene terephthalate (PET); 1500 d/2-ply, twist=370×370 TPM) were woven into a cord-like structure. Next, an impregnation machine (available from BENNINGER as Pilot Machine CPM4H-2D-V40-1E) was adopted, such that the cord-like structure was impregnated with the adhesive composition T1, and was then dried at 170° C. for 90 seconds and baked at 245° C. for 60 seconds to form an impregnated organic fiber cord fabric.

### EXAMPLE 3-2

In the present example, an impregnated organic fiber cord fabric was formed in the same manner with Example 3-1, except that the adhesive composition T1 was replaced by the adhesive composition T2.

### COMPARATIVE EXAMPLE 2-1

Two impregnation stages were carried out using the same impregnation machine. First, polyester yarn (available from Oriental Industries (Suzhou) Ltd.; content: polyethylene terephthalate (PET); 1500 d/2-ply, twist=370×370 TPM) were woven into a cord-like structure. Next, in the first impregnation stage, the cord-like structure was impregnated with the conventional pre-impregnation liquid P1, and was then dried at 170° C. for 90 seconds and baked at 245° C. for 60 seconds.

Subsequently, in the second impregnation stage, the baked cord-like structure was impregnated with a conventional RFL adhesive composition, and was then dried at 170° C. for 90 seconds and baked at 245° C. for 60 seconds to form an adhesive layer on the yarn surface, thereby obtaining the impregnated organic fiber cord fabric.

Subsequently, an organic fiber/rubber composite was formed by hot pressing rubber (the rubber composition is listed in Table 1 and is available from Kuo Chi Trading Co., Ltd.).

### COMPARATIVE EXAMPLE 2-2

In the present example, an impregnated organic fiber cord fabric was formed in the same manner with Comparative Example 2-1, except that in the first impregnation stage, the conventional pre-impregnation liquid P1 was replaced by the conventional pre-impregnation liquid P2.

### COMPARATIVE EXAMPLE 2-3

In the present example, an impregnated organic fiber cord fabric was formed in the same manner with Comparative Example 2-1, except that in the first impregnation stage, the conventional pre-impregnation liquid P1 was replaced by the adhesive composition T1.

### COMPARATIVE EXAMPLE 2-4

In the present example, an impregnated organic fiber cord fabric was formed in the same manner with Comparative Example 2-1, except that in the first impregnation stage, the conventional pre-impregnation liquid P1 was replaced by the adhesive composition T2.

Next, after hot-pressing of rubber to the impregnated organic fiber cord fabrics of Examples 3-1 to 3-2 and Comparative Examples 2-1 to 2-4 to form composites of organic fiber and rubber, the composites were subjected to an adhesion test, a heat resistance test and a fatigue resistance test. Specifically, ASTM method D4393 was adopted to perform a peeling test. ASTM method D6588 was adopted to perform the fatigue resistance test (testing conditions: compression ratio=20%; elongation ratio=6.5%; fatigue time=24 hrs; rotational speed=1800 rpm). The heat resistant test refers to a vulcanization treatment at 170° C. for 60 minutes and a following adhesion performance testing in accordance with ASTM method D4393. The test results are listed in Table 2.

TABLE 1

| Component | Parts by mass |
|---|---|
| Natural rubber (1# Natural rubber) | 90.0 |
| Styrene-Butadiene Rubber (1500) | 10.0 |
| Stearic acid (200-type, First Grade) | 2.0 |
| Promoter DM | 1.2 |
| Promoter TT | 0.03 |
| zinc oxide | 8.0 |
| carbon black (N330) | 35.0 |
| brimstone | 2.5 |
| Adhesive A | 0.8 |
| Adhesive RS | 0.96 |
| Total | 150.49 |

TABLE 2

| | | | Comparative | Comparative | Comparative | Comparative |
|---|---|---|---|---|---|---|
| | Example 3-1 | Example 3-2 | Example 2-1 | Example 2-2 | Example 2-3 | Example 2-4 |
| adhesion test | 220N, 100% | 213N, 100% | 245N, 100% | 228N, 100% | 229N, 100% | 210N, 80% |
| (peeling force, | | | | | | |
| rubber coverage) | | | | | | |
| heat resistance | 173N, 100% | 167N, 80% | 183N, 100% | 168N, 70% | 135N, 20% | 120N, 5% |
| (peeling force, | | | | | | |
| rubber coverage) | | | | | | |
| fatigue resistance | 90.1% | 92.3% | 89.5% | 90.7% | 82.1% | 83.0% |
| (breaking strength | | | | | | |
| retention rate) | | | | | | |

As can be seen from the testing results in Table 2, the adhesion, heat resistance, and fatigue resistance of the impregnated organic fiber cord fabric, which is impregnated with the adhesive composition of the present disclosure by one single impregnation stage, are similar to those of the conventional impregnated organic fiber cord fabric, which is formed by two impregnation stages (see the testing results of Examples 3-1 to 3-2 and Comparative Examples 2-1 to 2-2).

In addition, compared with the impregnated organic fiber cord fabrics formed by using conventional RFL adhesive composition in the second impregnation stage (see Comparative Examples 2-3 to 2-4), the impregnated organic fiber cord fabrics formed by using the adhesive composition of the present disclosure (see Examples 3-1 to 3-2) have significantly improved heat resistance and fatigue resistance. This is due to poor compatibility between halohydrin compound and blocked isocyanate compound, which are used to activate the organic fiber, and the conventional RFL adhesive composition. Therefore, the adhesive composition of the present disclosure not only poses no hazard to operators and the environment as it does not contain resorcinol and formaldehyde, but also increases the heat resistance and fatigue resistance of the organic fiber/rubber composite.

### Experiments on Different Yarn Types

### EXAMPLE 4-1

In the present example, an impregnated organic fiber cord fabric was formed in the same manner with Example 3-1, except that the polyester yarn was replaced by Nylon 66 yarn (1260d/2-ply, twist=350×350 TPM).

### EXAMPLE 4-2

In the present example, an impregnated organic fiber cord fabric was formed in the same manner with Example 3-2, except that the polyester yarn was replaced by poly(m-phenylene isophthalamide) fiber yarn (1500d/2-ply, twist=325×325 TPM).

### COMPARATIVE EXAMPLE 3-1

In the present example, an impregnated organic fiber cord fabric was formed in the same manner with Example 4-1, except that the adhesive composition T1 was replaced by the conventional RFL adhesive composition.

### COMPARATIVE EXAMPLE 3-2

In the present example, two impregnation stages were carried out using the same impregnation machine. First, poly(m-phenylene isophthalamide) fiber yarn (1500 d/2-ply, twist=325×325 TPM) were woven into a cord-like structure. Next, in the first impregnation stage, the cord-like structure was impregnated with the conventional pre-impregnation liquid P1, and was then dried at 170° C. for 90 seconds and baked at 245° C. for 60 seconds.

Subsequently, in the second impregnation stage, the baked cord-like structure was impregnated with a conventional RFL adhesive composition, and was then dried at 170° C. for 90 seconds and baked at 245° C. for 60 seconds to form an adhesive layer on the yarn surface, thereby obtaining the impregnated organic fiber cord fabric.

Subsequently, the impregnated organic fiber cord fabric is adhered to rubber by a hot pressing process to form an organic fiber/rubber composite (the rubber composition is listed in Table 1).

Next, each of the organic fiber/rubber composite of Examples 4-1 to 4-2 and Comparative Examples 3-1 to 3-2 was subjected to an adhesion test. Specifically, ASTM method D4393 was adopted to perform a peeling test. The test results are listed in Table 3.

TABLE 3

| | | | | Comparative |
|---|---|---|---|---|
| | Example | | Comparative | Example |
| | 4-1 | Example 4-2 | Example 3-1 | 3-2 |
| Yarn | Nylon 66 | poly(m- | Nylon 66 | poly(m- |
| material | (1260d/ | phenylene | (1260d/ | phenylene |
| | 2-ply) | isophthalamide) | 2-ply) | isophthalamide) |
| | | fiber | | fiber |
| | | (1500d/2-ply) | | (1500d/2ply) |
| adhesion | 207N, | 217N, | 193N, | 205N, |
| test | 90% | 80% | 85% | 85% |
| (peeling | | | | |
| force, | | | | |
| rubber | | | | |
| coverage) | | | | |

As can be seen from the testing results in Table 3, the adhesive composition of the present disclosure is suitable for yarn materials such as polyester, nylon or aromatic polyamide, and the adhesion performance thereof is similar to that of the conventional RFL adhesive composition.

In summary, the present disclosure provides an adhesive composition. Since the adhesive composition of the present disclosure does not contain resorcinol and formaldehyde, thereby posing no hazard to operators and the environment, as compared with the conventional RFL adhesive composition. Moreover, the adhesive composition of the present disclosure contains a halohydrin compound and a blocked isocyanate compound, and is capable of achieving excellent adhesion performance using one single impregnation stage. Compared to the conventional technique of using two impregnation stages, the adhesive composition of the present disclosure is cost-effective. Furthermore, the halohydrin compound and the blocked isocyanate compound, which are used to activate the organic fiber, have excellent compatibility with latex. Accordingly, the organic fiber/rubber composite impregnated with the adhesive composition of the present disclosure has excellent physical and mechanical properties, dry heat shrinkage, heat resistance, and fatigue resistance. Therefore, the adhesive composition of the present disclosure is suitable for use in a variety of organic fiber/rubber composite products.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An adhesive composition for bonding an organic fiber to rubber, comprising 10.0 to 30.0 parts of weight of a halohydrin compound, 10.0 to 30.0 parts of weight of a blocked isocyanate compound and 80.0 to 240.0 parts of weight of latex, wherein the adhesive composition does not include resorcinol, formaldehyde, and epoxy compound.

2. The adhesive composition of claim 1, wherein the halohydrin compound is a chlorohydrin compound.

3. The adhesive composition of claim 1, wherein the halohydrin compound is halogen-substituted sorbitol, halogen-substituted glycerol, or a combination thereof.

4. The adhesive composition of claim 3, wherein the halogen-substituted sorbitol is chloro-substituted sorbitol.

5. The adhesive composition of claim 3, wherein the halogen-substituted glycerol is chloro-substituted glycerol.

6. The adhesive composition of claim 1, wherein the latex is a copolymer of butadiene and vinyl pyridine.

7. A method for treating organic fiber, comprising:
impregnating an organic fiber or a fabric with the adhesive composition of claim 1; and
drying the organic fiber or the fabric.

8. The method of claim 7, wherein the organic fiber is selected from the group consisting of polyester fiber, nylon fiber, aromatic polyamide fiber, or a combination thereof.

9. The method of claim 8, wherein the polyester fiber is polyethylene terephthalate fiber.

10. The method of claim 8, wherein the nylon fiber is nylon 66 fiber.

11. The method of claim 8, wherein the aromatic polyamide fiber is poly(m-phenylene isophthalamide) fiber.

12. An organic fiber, wherein the organic fiber is prepared by the method of claim 7.

13. The organic fiber of claim 12, wherein the organic fiber is used in tires, hoses, conveyor belts or belts.

14. A method of forming organic fiber/rubber composite, comprising:
providing an impregnated organic fiber cord fabric having the adhesive composition of claim 1 thereon; and
adhering the impregnated organic fiber cord fabric to rubber.
